(19) United States
(12) Patent Application Publication
(10) Pub. No.: US 2025/0223856 A1
(43) Pub. Date: Jul. 10, 2025

(54) DOOR CHECK SYSTEM INCLUDING LOAD BALANCED CAM SLIDER ASSEMBLY

(71) Applicant: GM Global Technology Operations LLC, Detroit, MI (US)

(72) Inventor: Nadezhda Valerey Zhurba, Richmond Hill (CA)

(21) Appl. No.: 18/408,912

(22) Filed: Jan. 10, 2024

(51) Int. Cl. E05F 5/02

(52) U.S. Cl. CPC E05F 5/025; E05Y 2900/531

(57) ABSTRACT

A cam slider assembly for a door check system includes a first cam member including a first body having a first cam surface and a first base surface, a second cam member having a second body including a second cam surface and a second base surface, and a compression member extending about the first body and the second body. The compression member biases the first cam surface towards the second cam surface.

### INTRODUCTION

The subject disclosure relates to vehicles and, more particularly, to a door check system including a load balanced cam slider assembly for a vehicle.

Most vehicles include doors that facilitate entry into and egress from driver and passenger spaces. The doors are mounted to and pivot about a hinge. Typically a door check is mounted between the door and a vehicle frame. The door check dampens opening forces and establishes a number of discrete intermediate positions between a fully open position and a fully closed position. The door check typically includes a rod having a first end pivotally mounted to the vehicle frame and a second end that may move into and out from the door.

The rod typically includes one or more cam receiving recesses that define the discrete intermediate positions. The rod typically moves between two cam members as the door transitions between the fully open and the fully closed positions. The two cam members are mounted in a housing having an opening through which passes the rod. Each cam member is acted upon by a spring. Each spring biases a corresponding cam member towards the rod. As the rod moves into the opening, each cam member may nest into a corresponding cam receiving recess. The door may continue to move or be allowed to rest with the cam members holding the door in the intermediate position(s) defined by the cam receiving recesses.

Given their location, the number of components that form the assembly, and their prolific use, the door check requires periodic maintenance. Repairing the springs is a difficult task as they are often arranged in a sealed housing. In addition, the use of two distinct springs results in a non-uniform force application to the rod. The application of a non-uniform force may result in less than adequate door holding, particularly as the springs age. Accordingly, it is desirable to provide a door check that relies on fewer components that are less likely to wear in order to increase the time between needed maintenance cycles.

### SUMMARY

A cam slider assembly for a door check system, in accordance with a non-limiting example, includes a first cam member including a first body having a first cam surface a first base surface, a second cam member having a second body including a second cam surface and a second base surface, and a compression member extending about the first body and the second body. The compression member biases the first cam surface towards the second cam surface.

In addition to one or more of the features described herein the first base surface includes a first side, a second side, and a first compression member support surface extending between the first side and the second side.

In addition to one or more of the features described herein the first cam surface extends outwardly of the first body opposite the first compression member support surface between the first side and the second side.

In addition to one or more of the features described herein the second base surface includes a first side portion, a second side portion, and a second compression member support surface extending between the first side portion and the second side portion.

In addition to one or more of the features described herein the second cam surface extends outwardly of the second body opposite the second compression member support surface between the first side portion and the second side portion.

In addition to one or more of the features described herein a housing within which are arranged the first cam member and the second cam member, the housing having an opening.

In addition to one or more of the features described herein the first cam member, the second cam member, and the compression member float within the housing.

In addition to one or more of the features described herein the first base surface defines a first curvilinear surface and the second base surface comprises a second curvilinear surface.

In addition to one or more of the features described herein the compression member comprises a band that extends about each of the first curvilinear surface and the second curvilinear surface.

In addition to one or more of the features described herein the band comprises a continuous elastomeric band.

A vehicle, in accordance with a non-limiting example, includes a body including a door check rod. The body defines a passenger compartment having one or more seats. A dashboard arranged in the passenger compartment. A steering control is arranged between the dashboard and the one or more seats. A plurality of wheels is supported by the body. A door is pivotally mounted to the body. The door includes a cam slider assembly operatively connected to the door check rod. The cam slider assembly includes a first cam member including a first body having a first cam surface a first base surface, a second cam member including a second body having a second cam surface and a second base surface, and a compression member extending about the first body and the second body. The compression member biases the first cam surface towards the second cam surface.

In addition to one or more of the features described herein the first base surface includes a first side, a second side, and a first compression member support surface extending between the first side and the second side.

In addition to one or more of the features described herein the first cam surface extends outwardly of the first body opposite the first compression member support surface between the first side and the second side.

In addition to one or more of the features described herein the second base surface includes a first side portion, a second side portion, and a second compression member support surface extending between the first side portion and the second side portion.

In addition to one or more of the features described herein the second cam surface extends outwardly of the second body opposite the second compression member support surface between the first side portion and the second side portion.

In addition to one or more of the features described herein a housing supports the first cam member and the second cam member, the housing having an opening configured to slidingly receive the door check rod.

In addition to one or more of the features described herein the first cam member, the second cam member, and the compression member float within the housing.

In addition to one or more of the features described herein the first base surface defines a first curvilinear surface and the second base surface comprises a second curvilinear surface.

In addition to one or more of the features described herein the compression member comprises a band that extends about each of the first curvilinear surface and the second curvilinear surface.

In addition to one or more of the features described herein the band comprises a continuous elastomeric band.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a door check system having a load balanced cam slider, in accordance with a non-limiting example;

FIG. 2 is a left side view of the vehicle of FIG. 1 showing the door check system in a door open configuration, in accordance with a non-limiting example;

FIG. 3 is a cross-sectional view of the door check system of FIG. 2, in accordance with a non-limiting example;

FIG. 4 is a cross-sectional view of the load balanced cam slider of the door check system of FIG. 3, in accordance with a non-limiting example;

FIG. 5 is a rear perspective view of the load balanced cam slider of the door check system of FIG. 3, in accordance with a non-limiting example;

FIG. 6 depicts the load balanced cam slider arranged in a housing of the door check system of FIG. 5; and

FIG. 7 is a perspective view of the load balanced cam slider engaging a rod of the door check system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

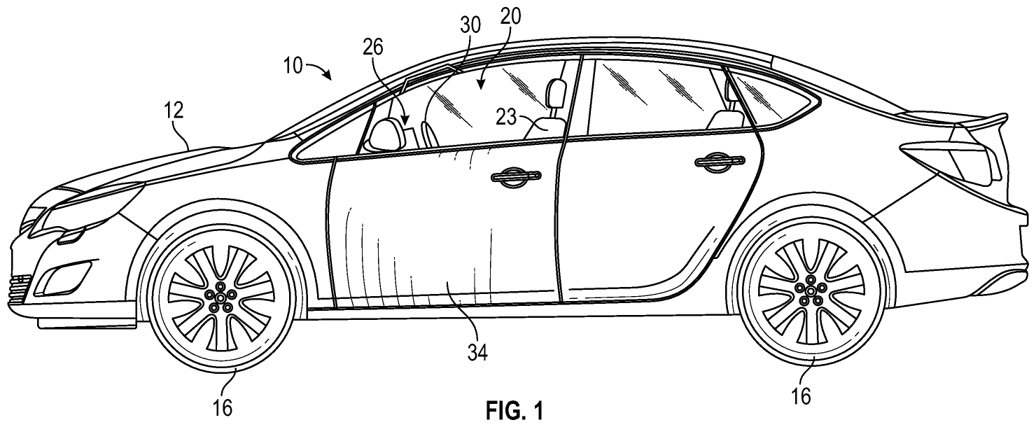

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. In a non-limiting example, vehicle 10 includes a plurality of doors, one of which is indicated at 34.

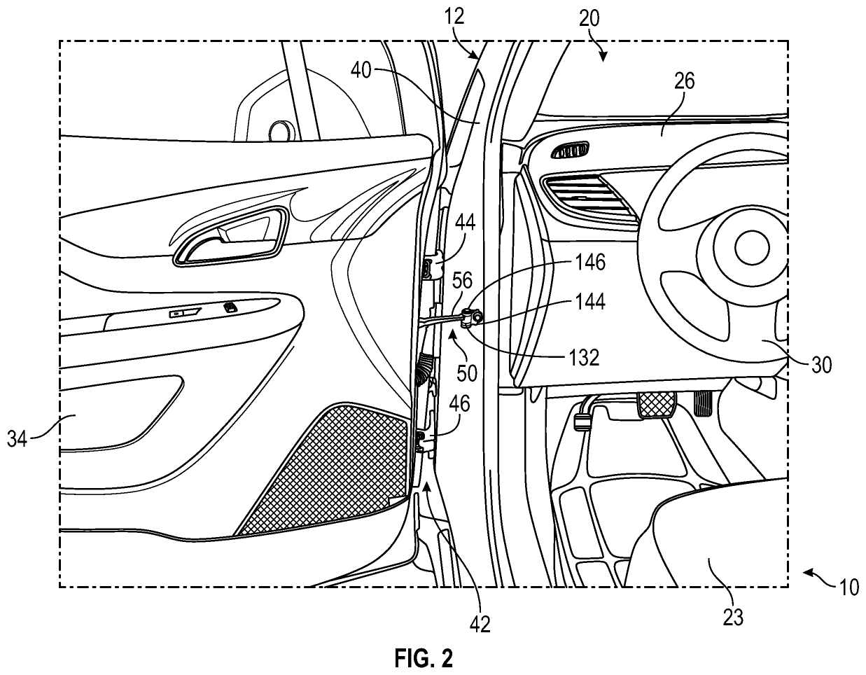

As shown in FIG. 2, door 34 is pivotally connected to an A-pillar 40 of body 12 through a hinge system 42. Hinge system 42 includes a first hinge member 44 and a second hinge member 46. Door 34 is also secured to body 12 through a door check system 50. Door check system 50 establishes a plurality of opening positions for door 34. That is, door 34 may transition between a closed configuration (FIG. 1) and an open configuration (FIG. 2) and a number of intermediate positions. Door check system 50 establishes intermediate positions for door 34. In other words door check system 50 may retain door 34 in one or more partially open (or partially closed) configurations.

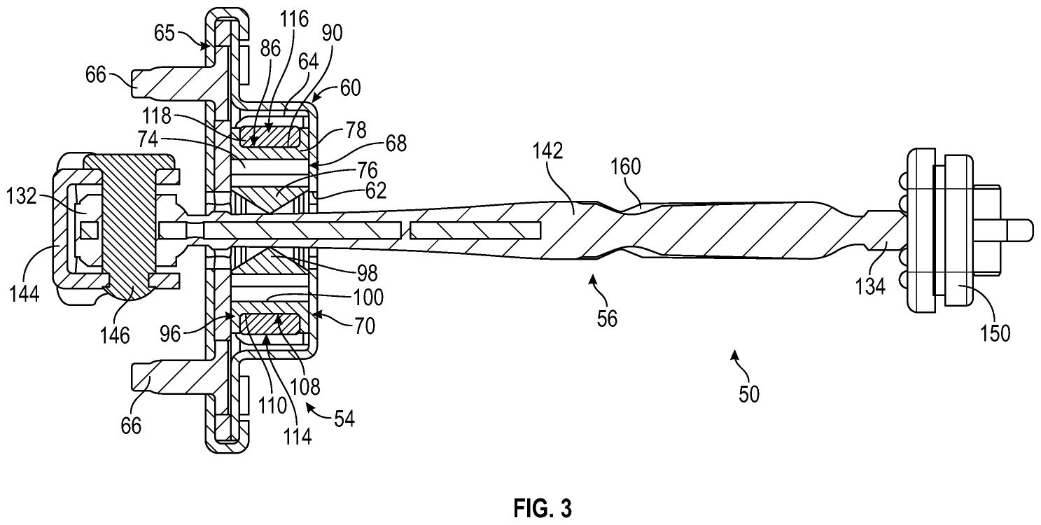

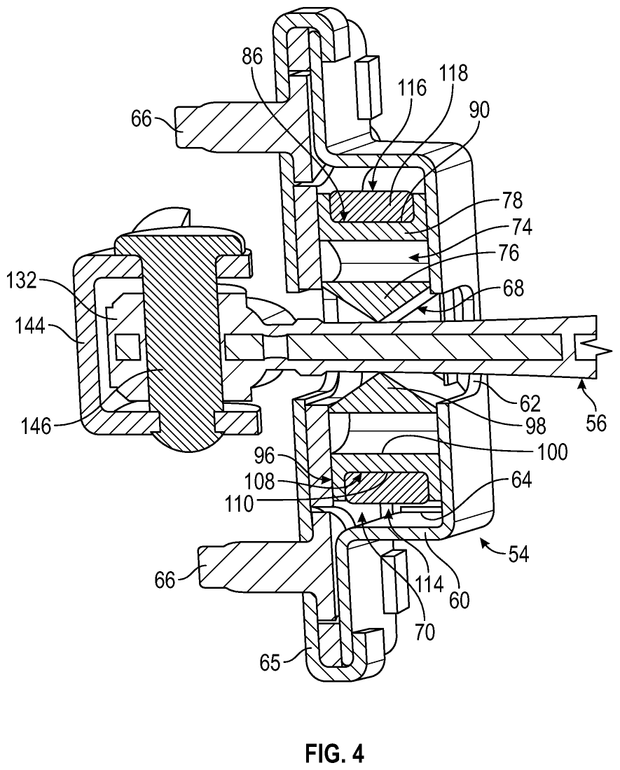

Referring to FIG. 3, door check mechanism 50 includes a cam slider assembly 54 mounted to door 34 and a door check rod 56 pivotally connected to A-pillar 40. Door check rod 56 extends through cam slider assembly 54 into door 34 as will be detailed herein. In a non-limiting example shown in FIGS. 3 and 4, cam slider assembly 54 includes a housing 60 that is mounted to door 34. Housing 60 includes an opening 62 that is receptive of door check rod 56 and a pocket 64. Housing 60 also includes a bracket 65 that includes mounting elements 66. Mounting elements 66 may detachably connect housing 60 to door 34.

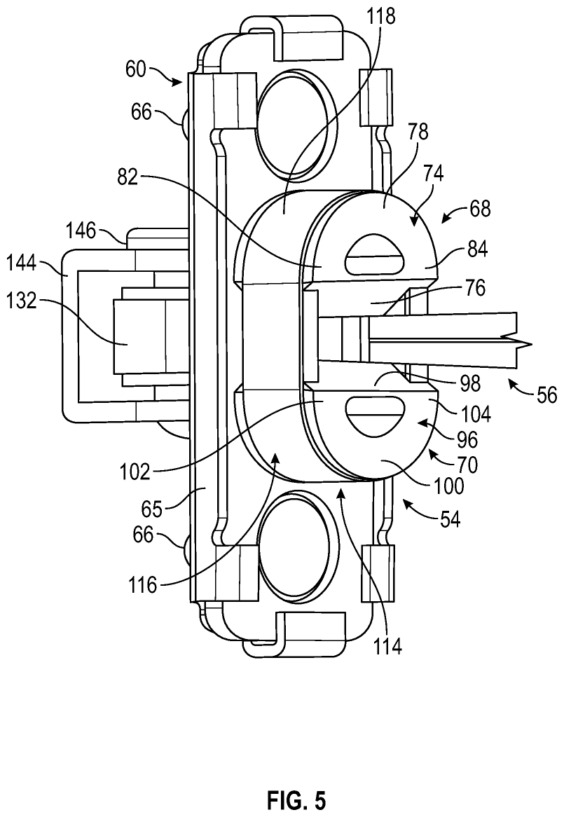

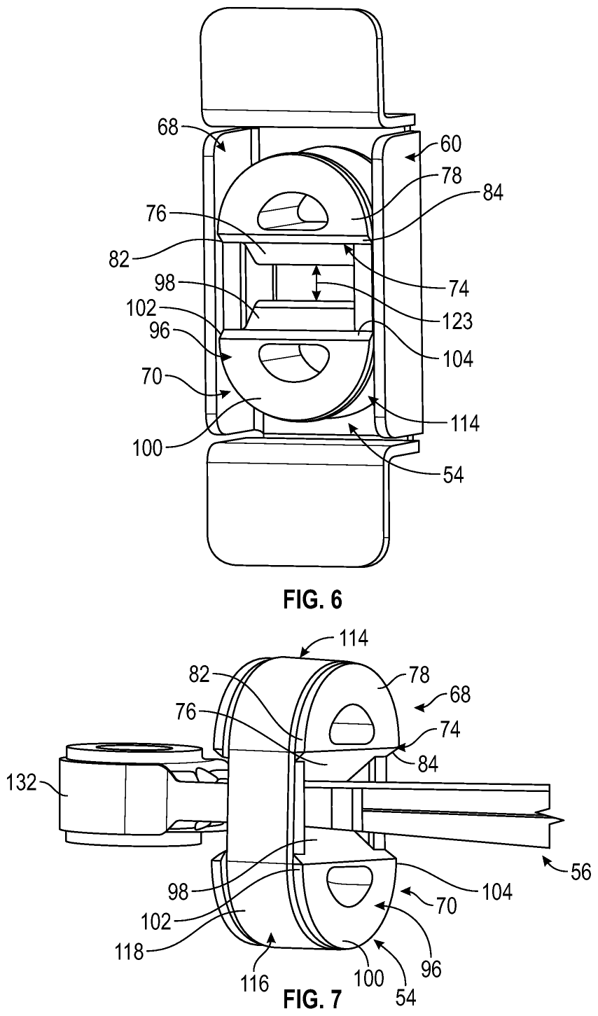

In a non-limiting example, cam slider assembly 54 includes a first cam member 68 and a second cam member 70 arranged in pocket 64 of housing 60. First cam member 68 and second cam member 70 float within housing 60. The term “float” should be understood to describe that neither first cam member 68 nor second cam member 70 is anchored to or within housing 60 as will be detailed more fully herein. First cam member 68 includes a first body 74 having a first cam surface 76 and a first base surface 78. As shown in FIGS. 5 and 6 and with continued reference to FIGS. 3 and 4, first cam member 68 includes a first side 82 and a second side 84 that is opposite to first side 82. First base surface 78 includes a first compression member support surface 86.

In a non-limiting example, while the shape may vary, first compression member support surface 86 is shown to take the form of a first curvilinear surface 90. Similarly, second cam member 70 includes a second body 96 having a second cam surface 98 and a second base surface 100. Second body 96 includes a first side portion 102 and a second side portion 104 (FIG. 5) that is opposite to first side portion 102. Second base surface 100 includes a second compression support surface 108. In a non-limiting example, while the shape may vary, second compression support surface 108 is shown to take the form of a second curvilinear surface 110.

In a non-limiting example, a compression member 114 extends about first cam member 68 and second cam member 70. Compression member 114 urges first cam surface 76 towards second cam surface 98 as shown in FIG. 5. In a non-limiting example, compression member 114 takes the form of a band 116 that rests within first compression member support surface 86 and second compression member support surface 108. In this manner, compression member 114 floats within housing 60 together with first cam member 68 and second cam member 70. That is, compression member 114 may move freely with first cam member 68 and second cam member 70.

In a non-limiting example, band 116 is shown to take the form of a continuous elastomeric band 118. However, it should be understood that band 116 may take on a variety of forms and be formed from a variety of materials so long as it may provide compression to first cam member 68 and second cam member 70 without being anchored to housing 60. Further, it should be understood that band 116 may be an assembly of components. In a non-limiting example illustrated in FIG. 6, a gap 123 may exist between first cam surface 76 and second cam surface 98. Gap 123 is substantially aligned with opening 62 in housing 60. Gap 123 is receptive of door check rod 56 as will be detailed more fully herein. The size of gap 123 may vary depending on vehicle model. In a non-limiting example, gap 123 facilitates unrestricted passage of door check rod 56 between first cam member 68 and second cam member 70 as shown in FIG. 7.

In non-limiting example illustrated in FIG. 3, door check rod 56 includes a first end 132, a second end 134, and an intermediate portion 142. A door pillar bracket 144 (FIG. 2) is arranged at first end 132. A cam pivot 146 secures first end 132 to door pillar bracket 144. Door pillar bracket 144 is secured to A-pillar 40 in a non-limiting example. A door bracket 150 is arranged at second end 134. Door bracket 150 is arranged within a door panel (not separately labeled) of door 34. Door bracket 150 limits the travel of door check rod 56. In a non-limiting example, intermediate portion 142 includes a hold valley 160 that establishes an intermediate position of door 34.

In operation, as door 34 transitions between a closed position (FIG. 1) and an open position (FIG. 2), cam slider assembly 54 slides over door check rod 56. As cam slider assembly 54 moves, first cam surface 76 and second cam surface 98 slide over an outer surface (not separately labeled) of door check rod 56. Compression member 114 maintains contact between first cam surface 76 and second cam surface 98 and door check rod 56. Cam slider assembly 54 continues along door check rod 56 until first cam surface 76 and second cam surface 98 drop into hold valley 160 at the urging of compression member 114.

In this position, door 34 may be tentatively held in the intermediate position until an additional closing or opening force is applied to door 34. The additional closing or opening force unseats first cam surface 76 and second cam surface 98 from hold valley 160 allowing cam slider assembly 54 to continue to slide over door check rod 56 unto door 34 is either fully closed or fully open. At this point, it should be understood that the number of hold valleys and, by extension, the corresponding number of intermediate positions may vary. It should further be understood that by replacing multiple springs with a single, floating compression member and floating cam sliders the load applied to the first and second cam members is substantially equal. By equalizing or balancing the load, the door check system is more reliable, last longer, and is easier and less costly to manufacture.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A cam slider assembly for a door check system comprising:
a first cam member including a first body having a first cam surface a first base surface;
a second cam member including a second body having a second cam surface and a second base surface; and
a compression member extending about the first body and the second body, the compression member biasing the first cam surface towards the second cam surface.

2. The cam slider assembly according to claim 1, wherein the first base surface includes a first side, a second side, and a first compression member support surface extending between the first side and the second side.

3. The cam slider assembly according to claim 2, wherein the first cam surface extends outwardly of the first body opposite the first compression member support surface between the first side and the second side.

4. The cam slider assembly according to claim 2, wherein the second base surface includes a first side portion, a second side portion, and a second compression member support surface extending between the first side portion and the second side portion.

5. The cam slider assembly according to claim 4, wherein the second cam surface extends outwardly of the second body opposite the second compression member support surface between the first side portion and the second side portion.

6. The cam slider assembly according to claim 4, further comprising a housing within which are arranged the first cam member and the second cam member, the housing having an opening.

7. The cam slider assembly according to claim 6, wherein the first cam member, the second cam member, and the compression member float within the housing.

8. The cam slider assembly according to claim 1, wherein the first base surface defines a first curvilinear surface and the second base surface comprises a second curvilinear surface.

9. The cam slider assembly according to claim 8, wherein the compression member comprises a band that extends about each of the first curvilinear surface and the second curvilinear surface.

10. The cam slider assembly according to claim 9, wherein the band comprises a continuous elastomeric band.

11. A vehicle comprising:
a body including a door check rod, the body defining a passenger compartment having one or more seats;
a dashboard arranged in the passenger compartment;
a steering control arranged between the dashboard and the one or more seats;
a plurality of wheels supported by the body; and
a door pivotally mounted to the body, the door including a cam slider assembly operatively connected to the door check rod, the cam slider assembly comprising:
a first cam member including a first body having a first cam surface a first base surface;
a second cam member including a second body having a second cam surface and a second base surface; and
a compression member extending about the first body and the second body, the compression member biasing the first cam surface towards the second cam surface.

12. The vehicle according to claim 11, wherein the first base surface includes a first side, a second side, and a first compression member support surface extending between the first side and the second side.

13. The vehicle according to claim 12, wherein the first cam surface extends outwardly of the first body opposite the first compression member support surface between the first side and the second side.

14. The vehicle according to claim 12, wherein the second base surface includes a first side portion, a second side portion, and a second compression member support surface extending between the first side portion and the second side portion.

15. The vehicle according to claim 14, wherein the second cam surface extends outwardly of the second body opposite the second compression member support surface between the first side portion and the second side portion.

16. The vehicle according to claim 14, further comprising a housing supporting the first cam member and the second cam member, the housing having an opening configured to slidingly receive the door check rod.

17. The vehicle according to claim 16, wherein the first cam member, the second cam member, and the compression member float within the housing.

18. The vehicle according to claim 11, wherein the first base surface defines a first curvilinear surface and the second base surface comprises a second curvilinear surface.

19. The vehicle according to claim 18, wherein the compression member comprises a band that extends about each of the first curvilinear surface and the second curvilinear surface.

20. The vehicle according to claim 19, wherein the band comprises a continuous elastomeric band.
